(19) United States
(12) Patent Application Publication
(10) Pub. No.: US 2006/0059702 A1
(43) Pub. Date: Mar. 23, 2006

(54) Measuring device for the incremental measurement of positions, actuating displacements or actuating angles and industrial truck equipped with such a measuring device

(76) Inventor: Robert Hammerl, Hohenthann (DE)

Correspondence Address: EDWARDS & ANGELL, LLP, P.O. BOX 55874, BOSTON, MA, 02205, US

(21) Appl. No.: 11/210,087

(22) Filed: Aug. 23, 2005

(30) Foreign Application Priority Data
Aug. 26, 2004 (DE) 10 2004 041 391.6

(51) Int. Cl. G01D 5/347

(52) U.S. Cl. 33/706

(57) ABSTRACT

For a measuring device for the incremental measurement of positions, actuating displacements or actuating angles taking into consideration the movement direction, comprising at least one first sensor arrangement (A) and at least one second sensor arrangement (B), which interact with at least one pitch track (100a), which can move in relation to the sensor arrangements, in order, during a relative movement between the sensor arrangements on the one hand and the pitch track on the other hand, to produce pulse signals which are offset with respect to one another by a defined phase, represent the relative movement in successive pulses and indicate the movement direction in the phase, the or at least one pitch track (100a) being designed to have a pitch which represents movement increments which determine the incremental measurement resolution capacity and produce pulses during the relative movement, it is proposed that the or at least one pitch track (100a) designed to have a further pitch which represents movement increments which are larger than the movement increments which determine the incremental measurement resolution capacity during the relative movement.

The invention relates to a measuring device for the incremental measurement of positions, actuating displacements or actuating angles taking into consideration the movement direction, comprising at least one first sensor arrangement and at least one second sensor arrangement, which interact with at least one pitch track, which can move in relation to the sensor arrangements, in order, during a relative movement between the sensor arrangements on the one hand and the pitch track on the other hand, to produce pulse signals which are offset with respect to one another by a defined phase, represent the relative movement in successive pulses and indicate the movement direction in the phase, the or at least one pitch track being designed to have a pitch which represents movement increments which determine the incremental measurement resolution capacity and produce pulses during the relative movement. Under consideration are primarily those measuring devices in the case of which the sensor arrangements (individual sensors or sensor tracks) interact in contactless fashion with the associated pitch track. Various suitable measurement principles are known. For example, the measurement may be carried out inductively, capacitively, optically or optoelectronically or magnetostrictively. In the case of a measuring device which is in the form of a linear displacement sensor, the pitch track is designed to be linear or rectilinear, for example formed by a sensor scale component. In the case of a measuring device in the form of an angular displacement encoder (sensor) or a rotary encoder (sensor), the pitch track extends in a circumferential direction and is generally in the form of a closed loop. The pitch track may in this case be formed by a sensor scale disc component. As regards a measuring device in accordance with the optical or optoelectronic measurement principle, provision may be made for the pitch track to be detected by the sensor arrangements optically in transmission or reflectively.

As mentioned, measuring devices are often designed to have sensor arrangements which, on the basis of the periodicity of the pulse signal, are offset by a phase angle of 90° with respect to one another (based on a period for the pulses which corresponds to a phase angle of 360°) in order to make it possible to detect or determine the movement direction. In this specialist field, such measuring devices are also referred to as two-channel incremental encoders (sensors).

The sensor arrangements (possibly sensor tracks), which are offset with respect to one another by the phase angle, conventionally sense a fixed pulse pattern, which is embodied in the pitch track and is strictly periodic along the entire extent of the pitch track such that, along the pitch track, all of the pitch track positions, which lie apart from one another by an actuating displacement corresponding to a phase angle of 360° or a multiple thereof, cannot be differentiated from one another from the pulse signals themselves, and it is therefore necessary when determining the position, the actuating displacement or the actuating angle to properly evaluate the pulse signals which are output by the sensor arrangements, to count the pulses to a certain extent when considering the movement direction information and, to a certain extent, to keep an account of the instantaneous position.

If, owing to faults, for example fault signals disrupting pulse evaluation in the electronics or, for example, contamination impairing the optical detection of the pitch track or the like, it should be the case that pulses are not correctly counted, over time a fault could accumulate in the “accountkeeping” such that a marked discrepancy between an actual actuating position and the actuating position determined by the evaluation electronics may occur. This may lead to serious problems, damage and possibly dangers, as is apparent using the example of an industrial truck in the case of which it may be necessary when loading and unloading and conveying to precisely move up to lifting positions or transverse displacement positions of a fork carrier which are determined by means of the measuring device.

This problem could be slightly alleviated by regularly moving up to a defined reference position which is defined, for example, by a stop or a positioning measure, and by the accountkeeping of the evaluation electronics then being reinitialized. However, this may be disruptive for normal operations, and in some situations may not be possible at all without human intervention and could also come too late in the case of serious faults.

The invention is based on the object of making it possible to determine instantaneous actuating positions in a fault-tolerant manner, or of at least making it possible for faults to be detected in an easily automated manner.

In order to achieve this object, the invention proposes for the initially mentioned measuring device that the or at least one pitch track is designed to have a further pitch which represents movement increments which are larger than the movement increments which determine the incremental measurement resolution capacity during the relative movement.

According to the invention, as in the prior art, positions, in particular relative positions, actuating displacement or actuating angle, can be detected on the basis of the pitch determining the incremental measurement resolution capacity and using these movement increments, which can in principle be detected, in the course of accountkeeping of the pulses occurring. It is also possible, on the basis of the further pitch and movement increments which are larger than the movement increments which determine the incremental measurement resolution capacity, to carry out additional “accountkeeping”, on the basis of which the accountkeeping of the smaller movement increments occurring can be checked and possibly corrected. For example, provision may be made, during a movement triggering pulses, for in each case a pulse to be omitted or suppressed in the pulse pattern, which occurs in the pulse signal of one or both of the sensor arrangements, at certain phase angle distances, based on a given actuating speed at certain time intervals, to be precise on the basis of the further pitch, which can be embodied in a corresponding design of the pitch track, in the case of an optical or optoelectronic detection, for example, by means of an omitted, light-transmissive point or a larger, opaque region, or by means of an omitted, reflecting point or a larger non-reflecting region or generally by means of corresponding designs of an optical element having the pitch track, possibly a grating. The same is possible in the case of sensors functioning according to other measurement principles, for example in the case of capacitive sensors which measure a change in the plate capacitance, in order to detect a movement of a plate along a movement line on the plane of the plate or parallel to said plate. In this case, the design may be such that, in accordance with a larger pitch, a maximum or a minimum of the detected capacitance occurs periodically, and such that this variation in capacitance is superimposed on a smaller change in capacitance or capacitance modulation which determines the resolution capacity of the measuring device. Corresponding modifications of conventional sensor arrangements or pitch tracks for other types of measurement principles are easily possible for those skilled in the art. Examples of measuring devices from the prior art which can be developed according to the invention are known from GB 2 273 567 A which discloses a known optical linear measuring device and a known capacitive linear measuring device.

According to the invention, it is possible to detect, for example by means of targeted “slipped pulses”, erroneous detections or erroneously counted or uncounted pulses at least in so far as a discrepancy between the bookkeeping of the pulses on the one hand and the occurrence of the “slipped pulse” on the other hand is recognized. If, for example, every twentieth pulse is defined as a slipped pulse (missing pulse), the evaluation software or evaluation electronics for the relevant measurement channel, preferably for both measurement channels, expects the slipped pulse after 19 counted pulses. The point at which the slipped pulse occurs, i.e. at which, without the further pitch, a normal pulse would inherently have to occur, can be defined by a pulse edge in the pulse signal of the respective other measurement channel. For this purpose, provision may be made of, in place of the conventional phase angle offset of 90°, a phase angle offset which is markedly larger than said conventional phase angle offset and is preferably a phase angle offset of 90°+/−z×180°, where z is a positive integer ≧1, for the phase offset between the two sensor arrangements. On the basis of the slipped pulse, recalibration of the accountkeeping of the pulses can take place, or, in the case of large discrepancies, a fault state is recognized, whereupon a corresponding fault message or a fault signal can be output.

It is generally proposed for, during a uniform relative movement, the first sensor arrangement and the second sensor arrangement to produce, owing to the pitch, periodic pulse signals having a periodicity which represents a periodicity of the pitch. As has already been indicated for the examples mentioned, consideration is given to the fact that, during the uniform relative movement, periodic discrepancies from the periodicity which represents the periodicity of the pitch occur, owing to the further pitch, in at least one of the periodic pulse signals, the discrepancies having a periodicity which represents a periodicity of the further pitch.

An expedient possibility in this case consists in the fact that, with respect to the remaining pulses which satisfy the periodicity which represents the periodicity of the pitch, a different pulse shape, possibly a different pulse height or pulse width, or an omitted pulse forms the discrepancy. The term “omitted pulse” is intended to mean the already mentioned possibility of a slipped pulse or missing pulse. Another possibility is that, with respect to interpulse periods between the pulses which satisfy the periodicity which represents the periodicity of the pitch, an interpulse period having a larger interpulse period width forms the discrepancy. The development proposal comprising “slipped pulse”, “missing pulse” or “omitted pulse” may in this context also be expressed as follows: the interpulse period forming the discrepancy may comprise a pulse position which, together with the remaining pulses, satisfies the periodicity which represents the periodicity of the pitch.

As has already been mentioned, provision may particularly advantageously be made for the first sensor arrangement and the second sensor arrangement, based on a period, which corresponds to a phase angle of 360°, of the pulses which satisfy the periodicity which represents the periodicity of the pitch, to be arranged in relation to the pitch track such that, during the uniform movement, the discrepancies are offset with respect to one another by a phase angle of at least 180°, preferably by a phase angle of 90°+/−z×180°, where z is an integer of at least 1, in the pulse signal of the first sensor arrangement and in the pulse signal of the second sensor arrangement. It is thus possible for the signals from one sensor arrangement to be used to determine the relative phase of the discrepancy in the signals from the other sensor arrangement.

The development proposals as mentioned above which relate to periodic discrepancies in at least one of the periodic pulse signals can be realized on the basis of one pitch track or two or more pitch tracks, which are associated with the first and the second sensor arrangement or else with at least one additionally provided sensor arrangement and make possible the incremental measurement at the incremental measurement resolution capacity. This pitch track or at least one of the pitch tracks used for this purpose can be modified according to the invention at regular intervals in order to bring about the periodic discrepancies in at least one of the periodic pulse signals.

In contrast, it is proposed as an alternative that the at least one pitch track is designed to have the pitch without the further pitch, and that at least one further pitch track is provided which is designed to have the further pitch. In accordance with this development proposal, a dedicated, additional pitch track, which is designed to have the further pitch, is provided for measurement control or measurement reference purposes.

Provision may advantageously be made for the further pitch track to be detected by one or more of the sensor arrangements which are provided in any case, i.e. for example by the first sensor arrangement and/or the second sensor arrangement, such that the discrepancies occur in the relevant sensor pulse signal. Another possibility is for at least one further sensor arrangement to be provided which interacts with the further pitch track and, during the/a uniform relative movement, produces, on the basis of the further pitch, a pulse signal having a periodicity which represents the periodicity of the further pitch. In accordance with this development proposal, an additional pulse signal acts as the reference or control.

As has already been mentioned, the measuring device according to the invention may be in the form of a linear displacement encoder (sensor) or a position encoder(sensor), in the case of which the pitch track or pitch tracks is/are in the form of a linear pitch track or pitch tracks extending between two ends. It has also already been mentioned that the measuring device may be in the form of a rotary encoder (sensor) or angular position encoder (sensor), in the case of which the pitch track or pitch tracks is/are in the form of a pitch track or pitch tracks extending in a circumferential direction and preferably forming a closed loop.

In accordance with another aspect, the invention also provides an industrial truck having a first load-bearing component and a second load-bearing component, which are provided such that they can move in relation to one another for the purpose of carrying out a conveying movement, a measuring device according to the invention being provided for the purpose of detecting the relative movement between the two load-bearing components, said measuring device lying directly between the two load-bearing components or between a drive component, associated with one of the load-bearing components, possibly a drive shaft or transmission component, and a reference component of the industrial truck.

Consideration is primarily given to the fact that a linear sensor scale, which forms the pitch track or pitch tracks, is provided on one of the load-bearing components (scale load-bearing component), and the sensor arrangements, designed to detect the sensor scale, are provided on the respective other load-bearing component (sensor load-bearing component).

Consideration is also given to the fact that a load-bearing component is a stand of a lifting mast or of an additional lifting device, and that the respective other load-bearing component is a lifting frame of the lifting mast or a side frame or a fork carrier of the additional lifting device. In this case, provision may be made for the stand to be the sensor load-bearing component and for the lifting frame or fork carrier or side frame to be the scale load-bearing component.

The invention will be explained in more detail below with reference to exemplary embodiments shown in the figures, in which:

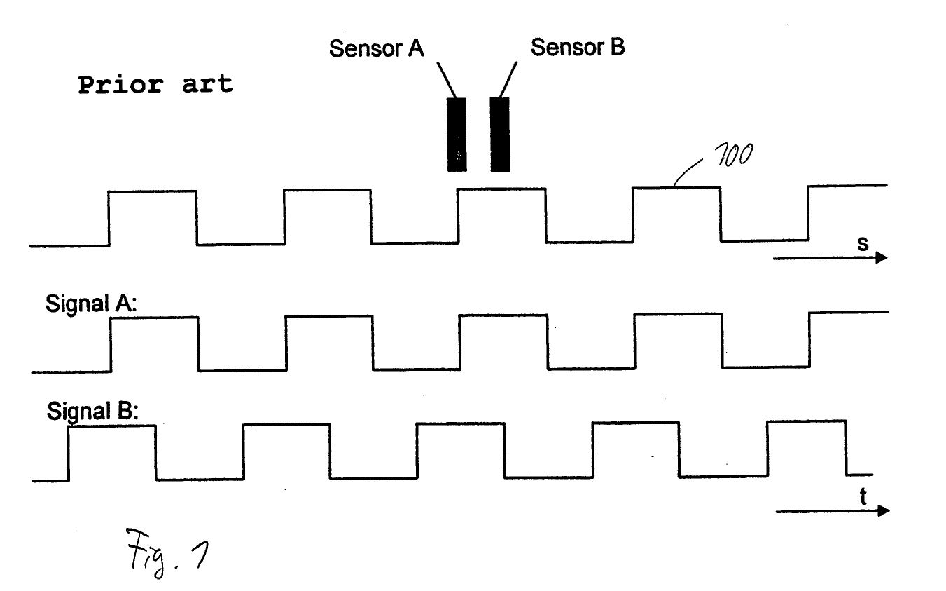

FIG. 1 shows a schematic of a measuring device of the prior art having two sensor arrangements and signals produced by these sensor arrangements during a uniform relative movement.

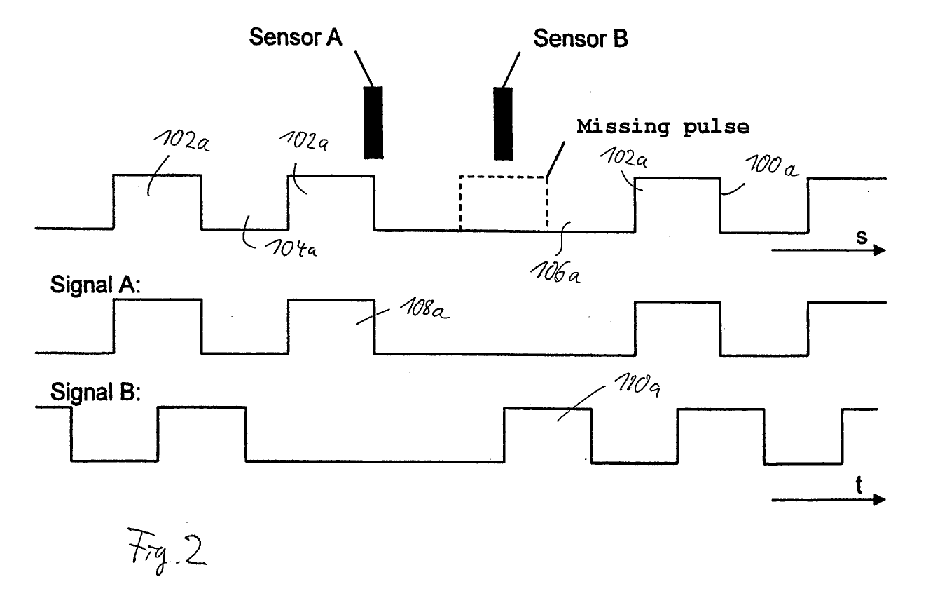

FIG. 2 shows a schematic of an example of a measuring device according to the invention having two sensor arrangements and signals produced by these sensor arrangements during a uniform relative movement.

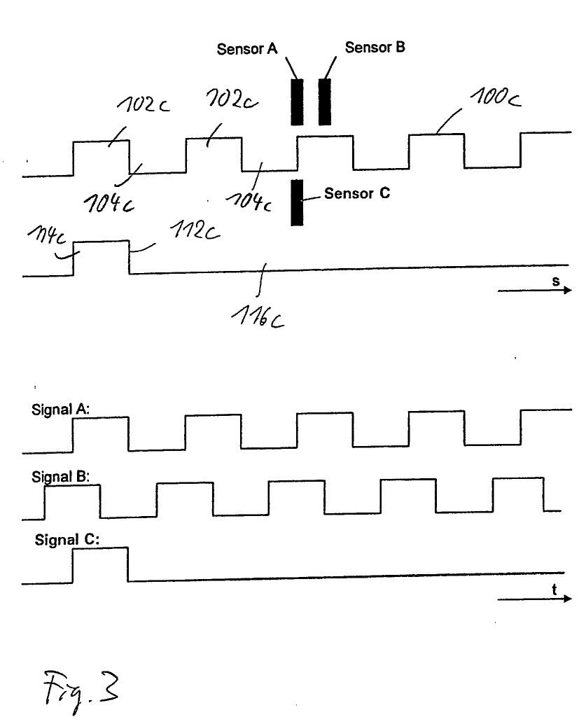

FIG. 3 shows a schematic of a further example of a measuring device according to the invention having three sensor arrangements and signals produced by these sensor arrangements during a uniform relative movement.

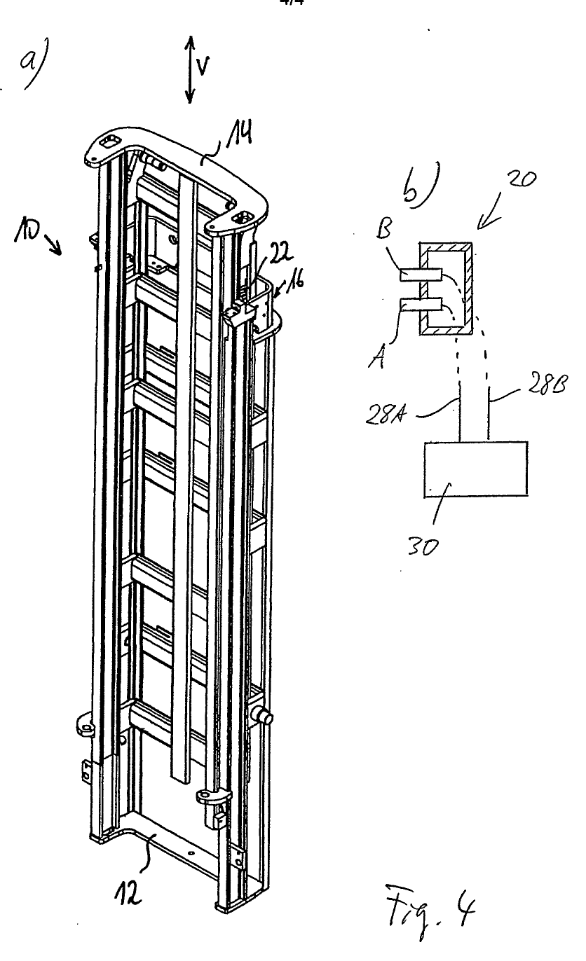

FIG. 4 shows, in subfigures FIG. 4a) and FIG. 4b), an example of a lifting mast of an industrial truck which is designed to have a linear measuring device according to the invention.

As shown in FIG. 1, a conventional, two-channel incremental sensor is equipped with two sensor arrangements, for example sensor tracks, which are offset by 90° with respect to the phase of the pulse signals produced by them, said sensor arrangements sensing a fixed pulse pattern 100 embodied by a pitch track. The line shown in FIG. 1 which represents the pitch track 100 may be summarized as an illustration of a linearly extending pitch track or as a development of a pitch track extending in the circumferential direction. The signals A and B produced by the sensor arrangements A and B image the pitch track and the relative movement between the pitch track and the sensor arrangements. The signals shown in FIG. 1 occur in the event of a uniform movement, i.e. of a movement having a constant speed or angular velocity without a change in direction. The instantaneous relative movement direction can be detected from the relative phase between the signals A and B.

In accordance with the exemplary embodiment illustrated schematically in FIG. 2, the periodicity of the pitch track is modified such that, after a number of in each case one pulse-outputting region 102a and regions 104a which lie between said regions 102a and do not output a pulse, a region 106a occurs which is larger than the regions 104a and does not output a pulse. A region 102a which is “omitted” to this extent is indicated by dashed lines and is identified as “missing pulse”.

This pitch pattern which satisfies a smaller periodicity and a larger periodicity is detected by the sensor arrangements A and B and produces the signals A and B in which the pitch pattern is reproduced. As shown in FIG. 2, a phase offset of 90°+180°, i.e. of 270°, is provided with respect to the conventional phase offset between the sensor arrangements along the pitch track, with the result that the centre of the “missing pulse” in one signal is characterized by the rising or falling edge of a respective pulse 108a or 110a in the respective other signal such that it is still possible for the movement to be detected in the region of the “slipped pulse”, and precise recalibration of the accountkeeping of the actuating movements is possible on the basis of the slipped pulse. It is generally expedient for a phase offset of 90°+z×180° to be provided, where z=integer of at least 1.

Owing to the slipped pulses (missing pulses) which are provided in a targeted manner, erroneous pulse accountkeeping can be detected. If, for example, a missing pulse occurs after each nineteenth pulse given correct pulse output and pulse detection, the evaluation software or evaluation electronics can expect the missing pulse for each measurement channel after 19 counted pulses. If in fact this does not occur although no reversal of the movement direction has been detected, a fault in the pulse output or pulse detection has occurred. Provision may be made for recalibration of the pulse evaluation, i.e. to a certain extent tracking of the accountkeeping of the detected pulses and thus of the actuating displacement or actuating angle detection, to take place on the basis of the missing pulse as long as there is only a small discrepancy. At least in the case of larger discrepancies, a fault message or a fault signal should be output in order to make possible commensurate responses, for example human intervention or calibration using an absolute reference.

In accordance with the exemplary embodiment in FIG. 3, the sensor arrangements A and B and the resultant signals A and B correspond to the solution from the prior art shown in FIG. 1. A further sensor arrangement C is provided in addition to the sensor arrangements A and B, and this further sensor arrangement C interacts with a dedicated pitch track 112c and outputs a signal C. As shown in the example in FIG. 3, the pitch track 112c is designed to have regions 114c which in each case output a pulse and correspond to the regions 102c of the pitch track 100c, but which lie apart from one another by regions 116c which in each case produce an interpulse period, and the two or more regions 102c and two or more regions 104c corresponding to the pitch track 100c.

FIG. 4a shows a lifting mast which is overall given the reference 10 and which comprises a stand 12, which is fixed in position on a frame (not illustrated) of an industrial truck, and a lifting frame 14 which is guided such that it can move in the direction of the double arrow V.

A fixing formation 16 is provided at one longitudinal end (the upper longitudinal end in FIG. 4a) of the stand 12 for the purpose of fixing a sensor unit, which is overall given the reference 20 in FIG. 4b. A sensor scale 22 is provided on the stand 14 opposite and facing the fixing formation 16. The sensor scale 22 is formed by pressing in depressions which are arranged successively at equal spacings in the direction of the double arrow V. In this case, the sensor scale is an incremental sensor scale 22. It may be a sensor scale which is separate from the stand 14, is attached to the stand 14 or is integral with the stand.

Pressing depressions into a side face of the lifting frame 14 or of a rod component may take place in a very simple manner using a tool rolling on the surface in the direction of the double arrow V. Projections made from hardened metal can be arranged distributed in the circumferential direction over the circumference of the tool, said projections pressing into the material of the lifting frame 14 or rod component when the tool is rolled on the surface. The procedure corresponds to beading of a surface.

In order to implement the proposal of the invention, the tool may be designed along its circumference which rolls on the surface such that, at certain angular distances or only at one angular position, a projection is omitted or designed to be wider in the circumferential direction such that corresponding modifications in the depression pattern of the sensor scale 22 result at regular intervals. These modifications may be in the form of, for example, “missing pulses” in pulse signals of the sensor unit. Reference is made to FIG. 2 and the associated embodiments above.

The sensor unit 20 comprises two sensors A and B which sense the pitch track, which is formed by the depressions and the elevations lying therebetween, of the sensor scale 22, for example in a contactless manner, for example optically or else mechanically with contact. Detection signals from the sensors are transmitted to a control unit or computer unit 30 via data lines 28A and 28B, said control unit or computer unit 30 counting the pulses whilst taking into consideration the directional information resulting from the phase and checking the count results with reference to the interpulse periods occurring in the signals.

The sensors A and B and the sensor unit 20 may be guided in a suitable manner in relation to the sensor scale in order to provide for a suitable detection accuracy. Reference is made, for example, to DE 103 14 795 A1 and preferably to German Patent Application No. 10 2004 033 170.7 filed by the applicant on Aug. 7, 2004. The solutions which can be gleaned therefrom can be developed in an expedient manner in accordance with the proposals of the invention.

1. Measuring device for the incremental measurement of positions, actuating displacements or actuating angles taking into consideration the movement direction, comprising at least one first sensor arrangement and at least one second sensor arrangement, which interact with at least one pitch track, which can move in relation to the sensor arrangements, in order, during a relative movement between the sensor arrangements on the one hand and the pitch track on the other hand, to produce pulse signals which are offset with respect to one another by a defined phase, represent the relative movement in successive pulses and indicate the movement direction in the phase, the or at least one pitch track being designed to have a pitch which represents movement increments which determine the incremental measurement resolution capacity and produce pulses during the relative movement, wherein the or at least one pitch track is designed to have a further pitch which represents movement increments which are larger than the movement increments which determine the incremental measurement resolution capacity during the relative movement.

2. Measuring device according to claim 1, wherein during a uniform relative movement, the first sensor arrangement and the second sensor arrangement produce, owing to the pitch, periodic pulse signals having a periodicity which represents a periodicity of the pitch.

3. Measuring device according to claim 2, wherein during the uniform relative movement, periodic discrepancies from the periodicity which represents the periodicity of the pitch occur, owing to the further pitch, in at least one of the periodic pulse signals, the discrepancies having a periodicity which represents a periodicity of the further pitch.

4. Measuring device according to claim 3, wherein with respect to the remaining pulses which satisfy the periodicity which represents the periodicity of the pitch, a different pulse shape, possibly a different pulse height or pulse width, or an omitted pulse forms the discrepancy.

5. Measuring device according to claim 3, wherein with respect to interpulse periods between the pulses which satisfy the periodicity which represents the periodicity of the pitch, an interpulse period having a larger interpulse period width forms the discrepancy.

6. Measuring device according to claim 5, wherein the interpulse period forming the discrepancy comprises a pulse position which, together with the remaining pulses, satisfies the periodicity which represents the periodicity of the pitch.

7. Measuring device according to claim 3, wherein the first sensor arrangement and the second sensor arrangement, based on a period, which corresponds to a phase angle of 360°, of the pulses which satisfy the periodicity which represents the periodicity of the pitch, are arranged in relation to the pitch track such that, during the uniform movement, the discrepancies are offset with respect to one another by a phase angle of at least 180°, preferably by a phase angle of 90°+/−z×180°, where z is an integer of at least 1, in the pulse signal of the first sensor arrangement and in the pulse signal of the second sensor arrangement.

8. Measuring device according to claim 1, wherein the at least one pitch track is designed to have the pitch without the further pitch, and in that at least one further pitch track is provided which is designed to have the further pitch.

9. Measuring device according to claim 8, wherein at least one further sensor arrangement is provided which interacts with the further pitch track and, during the/a uniform relative movement, produces, on the basis of the further pitch, a pulse signal having a periodicity which represents the periodicity of the further pitch.

10. Measuring device according to claim 1, in the form of a linear displacement encoder, in the case of which the pitch track or pitch tracks is/are in the form of a linear pitch track or pitch tracks extending between two ends.

11. Measuring device according to claim 1, in the form of a rotary encoder, in the case of which the pitch track or pitch tracks is/are in the form of a pitch track or pitch tracks extending in a circumferential direction and preferably forming a closed loop.

12. Industrial truck having a first load-bearing component and a second load-bearing component, which are provided such that they can move in relation to one another for the purpose of carrying out a conveying movement, a measuring device for the purpose of detecting the relative movement between the two load-bearing components, said measuring device lying directly between the two load-bearing components or between a drive component associated with one of the load-bearing components, possibly a drive shaft or transmission component, and a reference component of the industrial truck.

13. Industrial truck according to claim 12, wherein a linear sensor scale, which forms the pitch track or pitch tracks, is provided on one of the load-bearing component, and the sensor arrangements, designed to detect the sensor scale, are provided on the respective other load-bearing component.

14. Industrial truck according to claim 12, wherein a load-bearing component is a stand of a lifting mast or of an additional lifting device, and in that the respective other load-bearing component is a lifting frame of the lifting mast or a side frame or a fork carrier of the additional lifting device.

15. Industrial truck according to claim 14, wherein the stand is the sensor load-bearing component, and the lifting frame or fork carrier or side frame is the scale load-bearing component.

16. Industrial truck according to claim 12, wherein the measuring device comprises at least one first sensor arrangement and at least one second sensor arrangement, which interact with at least one pitch track, which can move in relation to the sensor arrangements, in order, during a relative movement between the sensor arrangements on the one hand and the pitch track on the other hand, to produce pulse signals which are offset with respect to one another by a defined phase, represent the relative movement in successive pulses and indicate the movement direction in the phase, the or at least one pitch track being designed to have a pitch which represents movement increments which determine the incremental measurement resolution capacity and produce pulses during the relative movement, and wherein the or at least one pitch track is designed to have a further pitch which represents movement increments which are larger than the movement increments which determine the incremental measurement resolution capacity during the relative movement.

17. Industrial truck according to claim 16, wherein the measuring device is in the form of a linear displacement encoder, in the case of which the pitch track or pitch tracks is/are in the form of a linear pitch track or pitch tracks extending between two ends.

18. Industrial truck according to claim 16, wherein the measuring device is in the form of a rotary encoder, in the case of which the pitch track or pitch tracks is/are in the form of a pitch track or pitch tracks extending in a circumferential direction and preferably forming a closed loop.
